(19) United States
(12) Patent Application Publication
(10) Pub. No.: US 2025/0252708 A1
(43) Pub. Date: Aug. 7, 2025

(54) AUTOMATIC RANGE-BASED POINT CLOUD DENSITY OPTIMIZATION

(71) Applicant: HUAWEI TECHNOLOGIES CO., LTD., Shenzhen (CN)

(72) Inventors: Yannis Yiming HE, Kanata (CA); Eduardo R. CORRAL-SOTO, Kanata (CA); Bingbing LIU, Shenzhen (CN)

(21) Appl. No.: 19/186,106

(22) Filed: Apr. 22, 2025

Related U.S. Application Data
(63) Continuation of application No. PCT/CN2023/070616, filed on Jan. 5, 2023.

(51) Int. Cl. G06V 10/72; G06V 10/77; G06V 10/774; G06V 10/776; G06V 10/82; G06V 20/64

(52) U.S. Cl. CPC G06V 10/72; G06V 10/7715; G06V 10/774; G06V 10/776; G06V 10/82; G06V 20/64

(57) ABSTRACT

There is provided a method of detecting objects in surroundings of a LiDAR system, the method comprising executing, using a Markov Chain Monte Carlo (MCMC) model, an iterative process for automatically generating a target density parameter for an in-use point cloud, the executing including acquiring a performance score from an object detection model; generating, using the MCMC model, a new candidate density parameter based on the performance score and a previous candidate density parameter; during a subsequent iteration, updating, using the MCMC model, the new candidate density parameter, thereby determining the target density parameter, the updating being based on a new performance score and the new candidate density parameter; generating, using a density adjustment function, a modified in-use point cloud; and generating, using the object detection model, a predicted output indicative of detected objects in the surroundings using the modified in-use point cloud.

### CROSS-REFERENCES TO RELATED APPLICATIONS

This application is a continuation of International Application No. PCT/CN 2023/070616, which is hereby incorporated by reference in its entirety.

### TECHNICAL FIELD

The present technology relates to 3D object detection, and specifically to methods and systems for detecting objects in surroundings of a LiDAR system.

### BACKGROUND

3D pointclouds consumed by autonomous driving perception modules are typically captured by LiDAR sensors with specific intrinsic and extrinsic parameters, such as vertical and horizontal resolution, field of view, and sensor installation, location, and pose. Consequently, point clouds from different datasets usually have different unique density distribution patterns. This creates a domain shift between different datasets which results in lack of generalization and poor performance of a perception model when trained on one dataset and evaluated on a different dataset.

Existing methods to adjust the density distributions of point clouds involve manual selection of parameters based on experimental tuning. However, it can be time-consuming to modify the point clouds from a dataset using a single set of manually-chosen parameters. Furthermore, training and evaluating a perception model with the modified data can introduce significant delays. Parameters also need to be re-selected if the experimental setup is changed, such as through a change of datasets, a change of perception model, etc. Processing and saving the data modified by manual density adjustment can also take additional processing time and storage.

There is therefore a desire for methods to densify or sparsify a point cloud which addresses at least some of the above described drawbacks.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

In accordance with one aspect of the present technology, there is provided a method of generating a modified point cloud based on a raw point cloud, the raw point cloud being captured by a LiDAR system, the method executable by a computing device communicatively coupled to the LiDAR system, the method comprising acquiring, by the computing device, the raw point cloud, the raw point cloud including a first set of points in a first pre-determined range interval and a second set of points in a second pre-determined distance interval, the first set of points associated with a first density distribution and the second set of points associated with a second density distribution, the first density distribution being different from the second density distribution; generating, by the computing device using a density adjustment function, a modified first set of points based on the first set of points and a first density parameter for the density adjustment function, the modified first set of points having a modified first density distribution that is different from the first density distribution, the first density parameter having been automatically determined for the first pre-determined distance interval during training of an object detection model, the object detection model to be used for detecting objects in the modified pointcloud; generating, by the computing device using the density adjustment function, a modified second set of points based on the second set of points and a second density parameter for the density adjustment function, the modified second set of points having a modified second density distribution that is different from the second density distribution, the second density parameter having been automatically determined for the second pre-determined distance interval during training of the object detection model; and generating, by the computing device, the modified point cloud based on a combination of the first modified set of points and the second modified set of points.

In some embodiments, the point cloud is a 3D point cloud.

In some embodiments, the object detection model is a centerpoint object detector configured to determine the center of a bounding box corresponding to an object.

In some embodiments, the object detection model is a Point-Voxel Region Based Convolutional Neural Network (PV-RCNN) object detector configured to generate 3D object proposals based on learned discriminative features of keypoints.

In some embodiments, the object detection model is a Point Density-A ware Voxel Network (PDV) object detector configured to generate spatially localized voxel features to improve bounding box confidences of 3D objects.

In some embodiments, the first set of points in the first pre-determined distance interval is within a first pre-determined range from the LiDAR system and the second set of points in the second pre-determined distance interval is within a second pre-determined range from the LiDAR system but above the first pre-determined range, the second pre-determined range greater than the first pre-determined range.

In some embodiments, the first density parameter and the second density parameter comprise at least one of a vertical sensor resolution, a horizontal sensor resolution, a distance range, a neighbor point association distance threshold, a subsampling factor, an interpolation factor, a vertical minimum angle between points, and a horizontal minimum angle between points.

According to yet another aspect of the present technology, there is provided a method of detecting objects in surroundings of a LiDAR system, the method executable by a computing device, the computing device being communicatively coupled to the L IDA R system, the method comprising executing, by the computing device employing a Markov Chain Monte Carlo (MCMC) model, an iterative process for automatically generating a target density parameter for an in-use point cloud, the executing including, during a given iteration of the iterative process, acquiring, by the computing device, a performance score from an object detection model, the performance score being indicative of a detection performance of the object detection model; generating, by the computing device employing the MCMC model, a new candidate density parameter based on the performance score and a previous candidate density parameter from a previous iteration, during a subsequent iteration of the iterative process, updating, by the computing device employing the MCMC model, the new candidate density parameter, thereby determining the target density parameter, the updating being based on a new performance score and the new candidate density parameter from the given iteration, the new performance score being indicative of a detection performance of the object detection model on a modified training point cloud generated using the training point cloud and the new candidate density parameter; generating, by the computing device employing a density adjustment function, a modified in-use point cloud using the in-use point cloud and the target density parameter, the in-use point cloud having been captured by the LiDAR system in the surroundings, the modified in-use point cloud having a different density distribution than the in-use point cloud; and generating, by the computing device employing the object detection model, a predicted output indicative of detected objects in the surroundings using the modified in-use point cloud, instead of the in-use point cloud.

In some embodiments, the object detection model is a centerpoint object detector configured to determine the center of a bounding box corresponding to an object.

In some embodiments, the object detection model is a Point-Voxel Region Based Convolutional Neural Network (PV-RCNN) object detector configured to generate 3D object proposals based on learned discriminative features of keypoints.

In some embodiments, the object detection model is a Point Density-Aware Voxel Network (PDV) object detector configured to generate spatially localized voxel features to improve bounding box confidences of 3D objects.

In some embodiments, the target density parameter, the new candidate density parameter, and the previous candidate density parameter comprise at least one of a vertical sensor resolution, a horizontal sensor resolution, a distance range, a neighbor point association distance threshold, a subsampling factor, an interpolation factor, a vertical minimum angle between points, and a horizontal minimum angle between points.

In some embodiments, the performance score comprises a vector of posterior probabilities indicative of the performance of the object detection model, the vector comprising at least a first component representative of an overall posterior probability of the in-use point cloud and a subsequent component representative of a posterior probability in a pre-determined distance interval of the in-use point cloud.

In some embodiments, the target density parameter maximizes the first component representative of the overall posterior probability of the in-use point cloud.

In some embodiments, the in-use point cloud and the modified in-use point cloud comprise a first set of points in a first pre-determined distance interval and a second set of points in a second pre-determined distance interval, the first set of points associated with a first density distribution and the second set of points associated with a second density distribution, the first density distribution being different from the second density distribution, and the target density parameter, the new candidate density parameter, and the previous candidate density parameter comprise a vector of density parameters, the vector comprising at least a first component representative of a first density parameter in the first pre-determined range and a second component representative of a second density parameter in the second pre-determined range.

According to yet another aspect of the present technology, there is provided a computing device for generating a modified point cloud based on a raw point cloud, the raw point cloud being captured by a LiDAR system, the computing device communicatively coupled to the LiDAR system, the computing device being configured to acquire the raw point cloud, the raw point cloud including a first set of points in a first pre-determined range interval and a second set of points in a second pre-determined distance interval, the first set of points associated with a first density distribution and the second set of points associated with a second density distribution, the first density distribution being different from the second density distribution; generate, using a density adjustment function, a modified first set of points based on the first set of points and a first density parameter for the density adjustment function, the modified first set of points having a modified first density distribution that is different from the first density distribution, the first density parameter having been automatically determined for the first pre-determined distance interval during training of an object detection model, the object detection model to be used for detecting objects in the modified point cloud; generate, using the density adjustment function, a modified second set of points based on the second set of points and a second density parameter for the density adjustment function, the modified second set of points having a modified second density distribution that is different from the second density distribution, the second density parameter having been automatically determined for the second pre-determined distance interval during training of the object detection model; and generate the modified point cloud based on a combination of the first modified set of points and the second modified set of points.

According to yet another aspect of the present technology, there is provided a computing device for detecting objects in surroundings of a LiDAR system, the computing device being communicatively coupled to the L IDA R system, the computing device being configured to execute, employing a Markov Chain Monte Carlo (MCMC) model, an iterative process for automatically generating a target density parameter for an in-use point cloud, the executing including, during a given iteration of the iterative process, acquire a performance score from an object detection model, the performance score being indicative of a detection performance of the object detection model; generate, employing the MCMC model, a new candidate density parameter based on the performance score and a previous candidate density parameter from a previous iteration, during a subsequent iteration of the iterative process, update, employing the MCMC model, the new candidate density parameter, thereby determining the target density parameter, the updating being based on a new performance score and the new candidate density parameter from the given iteration, the new performance score being indicative of a detection performance of the object detection model on a modified training point cloud generated using the training point cloud and the new candidate density parameter; generate, employing a density adjustment function, a modified in-use point cloud using the in-use point cloud and the target density parameter, the in-use point cloud having been captured by the LiDAR system in the surroundings, the modified in-use point cloud having a different density distribution than the in-use point cloud; and generate, employing the object detection model, a predicted output indicative of detected objects in the surroundings using the modified in-use point cloud, instead of the in-use point cloud.

In some embodiments, the target density parameter of the computing device for detecting objects may include a first density parameter for the density adjustment function and a second density parameter for the density adjustment function.

In some other embodiments, the computing device for detecting objects may be further configured to: acquire the in-use point cloud, the in-use point cloud includes a first set of points in a first pre-determined range interval and a second set of points in a second pre-determined distance interval, the first set of points associated with a first density distribution and the second set of points associated with a second density distribution, the first density distribution being different from the second density distribution; generate, using the density adjustment function, a modified first set of points based on the first set of points and a first density parameter for the density adjustment function, the modified first set of points having a modified first density distribution that is different from the first density distribution, the first density parameter having been automatically determined for the first pre-determined distance interval during training of the object detection model; generate, using the density adjustment function, a modified second set of points based on the second set of points and a second density parameter for the density adjustment function, the modified second set of points having a modified second density distribution that is different from the second density distribution, the second density parameter having been automatically determined for the second pre-determined distance interval during training of the object detection model; and generate the modified in-use point cloud based on a combination of the modified first set of points and the modified second set of points.

In the context of the present specification, “electronic device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROM s, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a block diagram of an example computing device, in accordance with one non-limiting embodiment of the present technology.

FIG. 2 depicts point clouds captured by a LiDAR system, in accordance with at least some non-limiting embodiments of the present technology.

FIG. 3 depicts a plot of density distributions of points in a point cloud captured by the LiDAR system, in accordance with at least some non-limiting embodiments of the present technology.

FIG. 4 depicts a schematic diagram illustrating an object detection system being executable by the computing device of FIG. 1, in accordance with at least some non-limiting embodiments of the present technology.

FIG. 5 depicts a 2D array of density parameters in a plurality of ranges retrieved from a storage, the storage being accessible by the computing device of FIG. 1, in accordance with at least some non-limiting embodiments of the present technology.

FIG. 6 depicts a spatially partitioned point cloud, in accordance with at least some non-limiting embodiments of the present technology.

FIG. 7 depicts a block diagram of a density optimization module being executable by the computing device of FIG. 1, in accordance with one non-limiting embodiment of the present technology.

FIG. 8A depicts a schematic diagram illustrating a Markov Chain Monte Carlo (MCMC) system being executable by the computing device of FIG. 1, in accordance with one non-limiting embodiment of the present technology.

FIG. 8B depicts an arrow diagram illustrating an evolution of target density parameters during execution of the MCMC system of FIG. 8A, in accordance with one non-limiting embodiment of the present technology.

FIG. 9 depicts a flowchart illustrating an example method for generating a modified point cloud, the method being executable by the computing device of FIG. 1 in accordance with one non-limiting embodiment of the present technology.

FIG. 10 depicts a flowchart illustrating an example method for detecting objects in surroundings of a LiDAR system, the method being executable by the computing device of FIG. 1 in accordance with one non-limiting embodiment of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

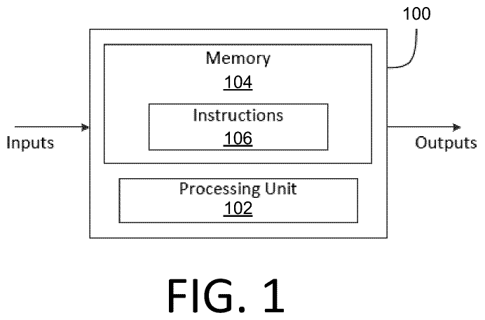

With reference to FIG. 1, part or all of the embodiments of the devices, systems and methods described herein may be implemented in a combination of both hardware and software.

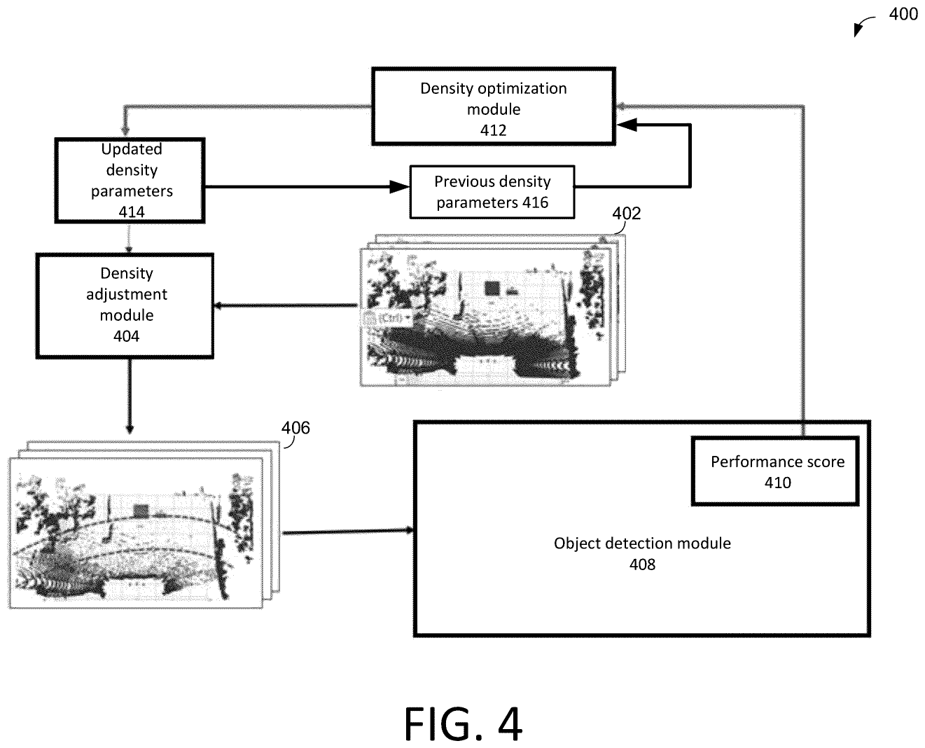

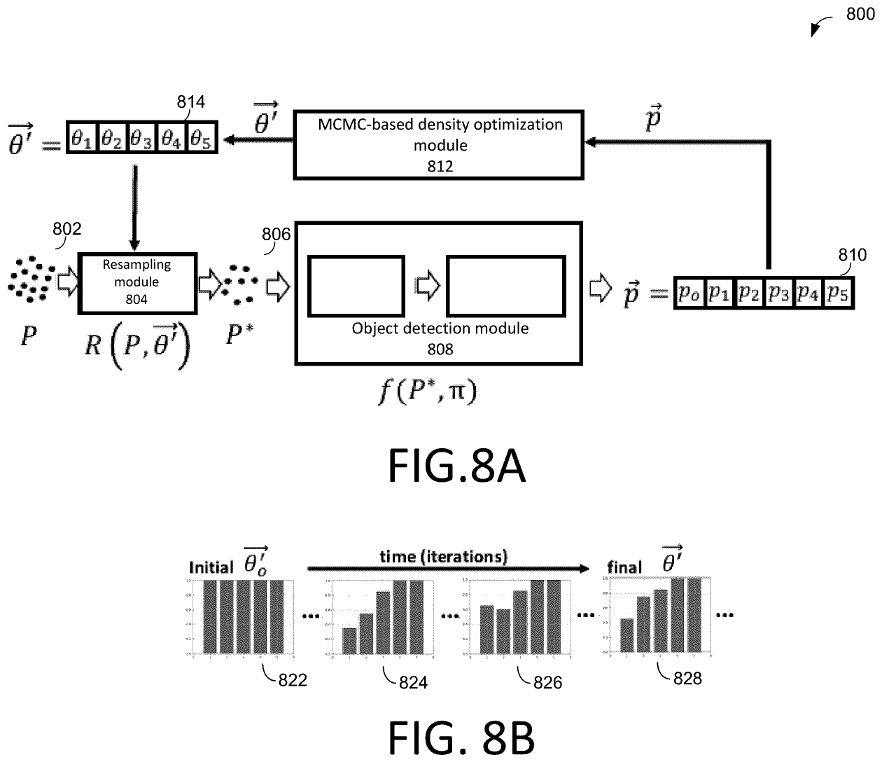

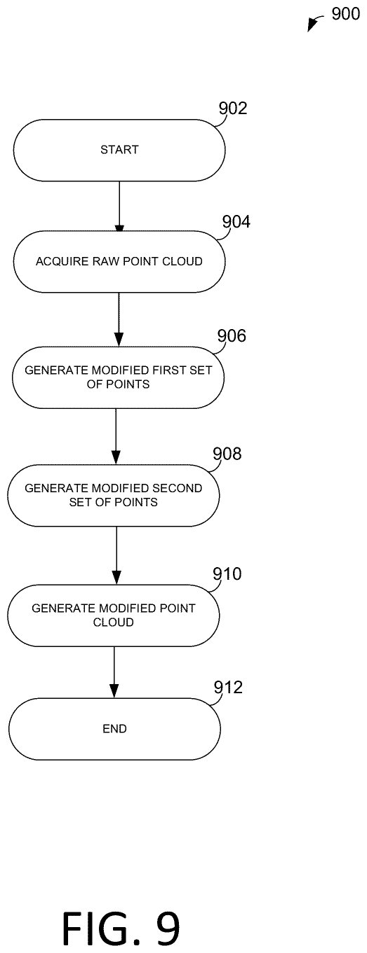

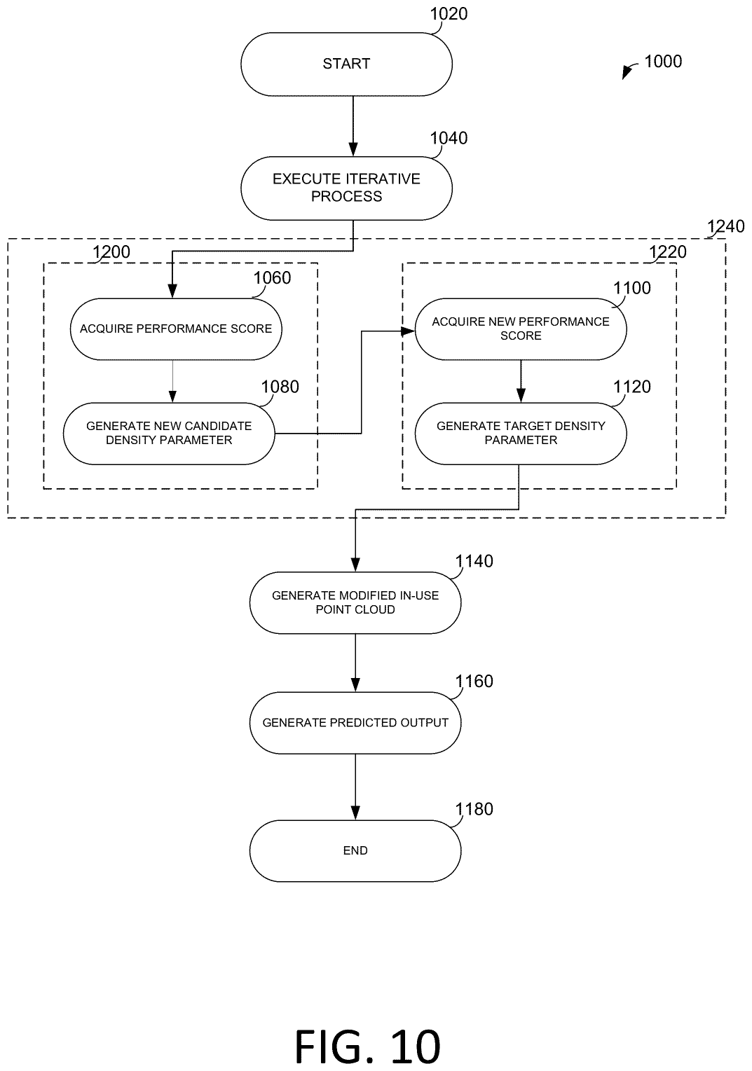

FIG. 1 illustrates an example computing device 100 which may be used to implement an object detection system 400 of FIG. 4, an MCMC system 800 of FIG. 8, a method 900 of FIG. 9, and/or a method 1000 of FIG. 10. The computing device 100 includes a processing unit 102 and a memory 104 which has stored therein computer-executable instructions 106. The processing unit 102 may include any suitable devices configured to implement the functionality of the object detection system 400, the MCMC system 800, the method 900, and/or the method 1000 such that the computer-executable instructions 106, when executed by the computing device 100 or other programmable apparatus, may cause the functions/acts/steps performed by object detection system 400, the MCMC system 800, the method 900, and/or the method 1000 as described herein to be executed. The processing unit 102 may include, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, custom-designed analog and/or digital circuits, or any combination thereof. It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

The memory 104 may include any suitable known or other machine-readable storage medium. The memory 104 may include non-transitory computer readable storage medium, for example, but not limited to, an electronic, magnetic, optical, electromagnetic, infrared, or semiconductor system, apparatus, or device, or any suitable combination of the foregoing. The memory 104 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 104 may include any storage means (e.g., devices) suitable for retrievably storing the computer-executable instructions 106 executable by processing unit 102.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

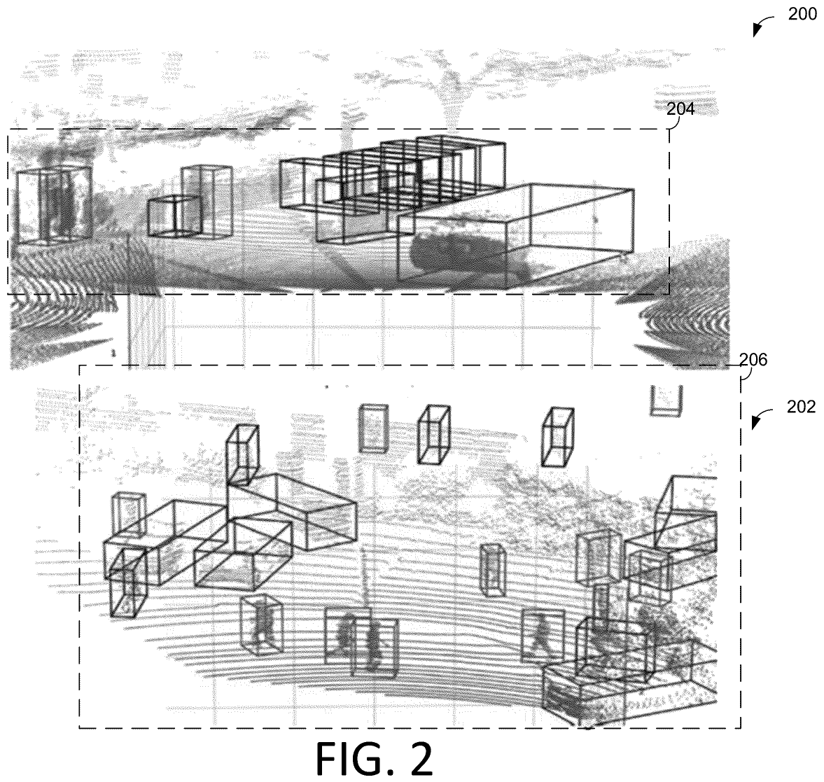

Referring to FIG. 2, there is depicted a first point cloud 200 corresponding to a first dataset captured by a first LiDAR system at a first geographic location (not shown), and a second point cloud 202 corresponding to a second dataset captured by a second LiDAR system at a second geographic location (not shown), the first LiDAR system being different from the second LiDAR system, the first LiDAR system and the second LiDAR system being communicatively coupled to the computing device 100, and the first geographic location being different from the second geographic location. The first LiDAR system and the second LiDAR system may each include a plurality of sensors (not shown) configured to detect 3D objects at the first geographical location and the second geographical location, respectively. The first point cloud 200 captured by the first LiDAR system may include a plurality of first detected 3D objects 204, and the second point cloud 202 captured by the second LiDAR system may include a plurality of second detected 3D objects 206. Each of the first detected 3D objects 204 and the second detected 3D objects 206 may have associated a corresponding number of 3D points in the first dataset and the second dataset, respectively. Depending on intrinsic and extrinsic properties of the first LiDAR system and the second LiDAR system, the first detected 3D objects 204 may be denser than the second detected 3D objects 206. In a non-limiting example, each of the first detected 3D objects 204 may have on the order of 10⁴ associated points in the first dataset, while each of the second detected 3D objects 206 may have on the order of 101 associated points in the second dataset. As described in further detail hereinbelow, training of a LiDAR perception module on the first dataset may result in a bias towards dense nearby objects, such as the first detected 3D objects 204, while paying less attention during training to more distant sparse objects, such as the second detected 3D objects 206. In some embodiments, each of the first detected 3D objects 204 and the second detected 3D objects 206 may be defined by a bounding box, as described in further detail hereinbelow.

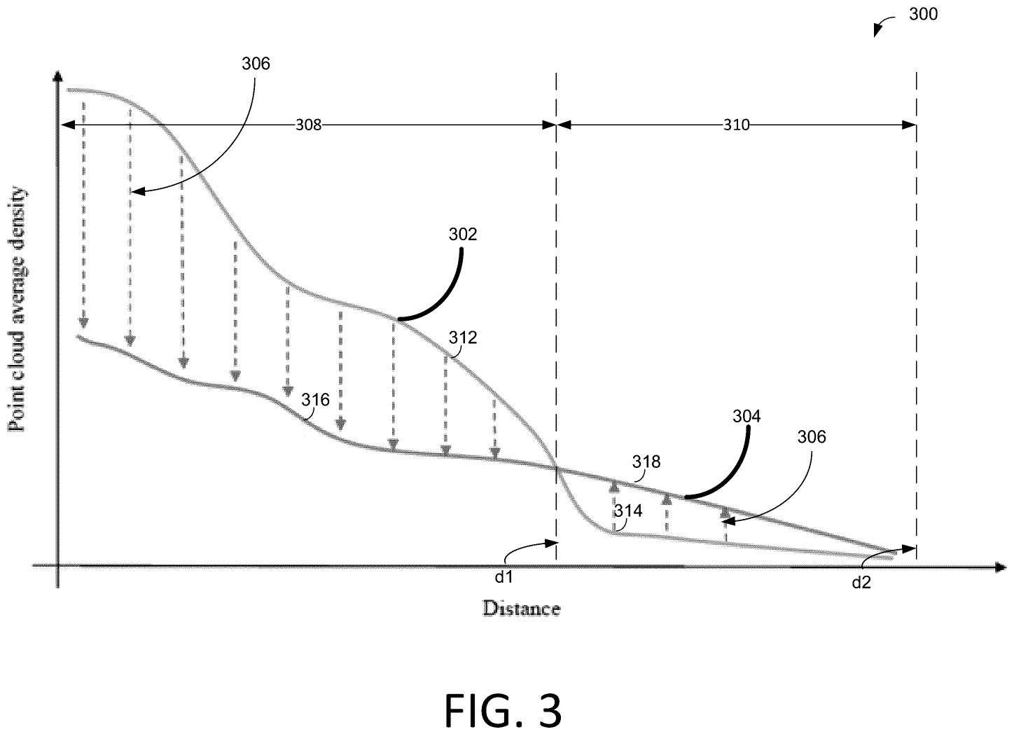

Referring to FIG. 3, a plot 300 of density distributions of points in a point cloud captured by a LiDAR system will be described, in accordance with a non-limiting embodiment of the present technology. The plot 300 includes an available density distribution 302 and a given density distribution 304, where the given density distribution 304 is generated from the available density distribution 302 via a density adjustment function 306. The available density distribution 302 may characterize an available point cloud obtained from an available dataset by the LiDAR system, for instance the first point cloud 200 or the second point cloud 202, where the available density distribution 302 is unadjusted. In a non-limiting embodiment of the present technology, as a distance from the LiDAR system (x-axis of the plot 300) increases, a point cloud average density (y-axis of the plot 300) may decrease. In some embodiments, the distance from the LIDAR system may be measured in meters (m), while the point cloud average density may be measured in points per cubic meter (1/m³).

The given density distribution 304 may be defined as a density distribution that optimizes the performance of a LiDAR perception module (also referred to as an “object detection module”, “detection module”, or variations thereof), the LiDAR perception module being executable by the computing device 100. As the available density distribution 302 approaches the given density distribution 304, the computing device 100 using the LiDAR perception module is expected to perform and generalize better at different distance intervals, as described in further detail hereinbelow. However, the given density distribution 304 may be unknown a priori. In some embodiments, the density adjustment function 306 may involve, for example, lowering the point cloud average density in a first pre-determined distance interval 308 (also referred to as a “range interval” or simply as a “range”) defined within a first distance d1, and increasing the point cloud average density in a second pre-determined distance interval 310 defined between the first distance d1 and a second distance d2. In some embodiments, lowering the point cloud average density in the first pre-determined distance interval 308 may include down-sampling representative points from the available point cloud, e.g. the first point cloud 200, and increasing the point cloud average density in the second pre-determined distance interval 310 may be accomplished by up-sampling representative points from the available point cloud. In some embodiments, the available density distribution 302 may include a first density distribution component 312 defined in the first pre-determined distance interval 308 and a second density distribution 314 defined in the second pre-determined distance interval 310, and the given density distribution 304 may include a first density distribution component 316 defined in the first pre-determined distance interval 308 and a second density distribution component 318 defined in the second pre-determined distance interval 310.

In some embodiments, lowering the point cloud average density in the first pre-determined distance interval 308 may include down-sampling representative points from the first density distribution component 312 until the point cloud average density of the first density distribution component 312 matches the first density distribution component 316. In some embodiments, increasing the point cloud average density in the second pre-determined distance interval 310 may include up-sampling representative points from the second density distribution component 314 until the point cloud average density of the second density distribution component 314 matches the second density distribution component 318.

In some embodiments, the available density distribution 302 and the given density distribution 304 may be continuous functions (i.e. involving no abrupt changes or discontinuities). In some non-limiting embodiments of the present technology, the available density distribution 302 and the given density distribution 304 may be discrete functions.

Referring to FIG. 4, an object detection system 400 for detecting objects in surroundings of a LiDAR system, according to a non-limiting embodiment of the present technology, will be described. The object detection system 400 may be executable on the computing device 100, and include a raw point cloud 402 captured by a LiDAR system, for instance the first point cloud 200 captured by the first LiDAR system or the second point cloud 202 captured by the second LiDAR system.

A density adjustment module 404 may receive the raw point cloud 402, the density adjustment module being executable by the computing device 100. The computing device 100, using the density adjustment module 404, may implement the density adjustment function 306 on the available density distribution 302 to generate a modified density distribution. The modified density distribution may be defined as an intermediate density distribution between the available density distribution 302 and the given density distribution 304 (see FIG. 3). The modified density distribution may be obtained by iteratively modifying the available density distribution 302 as described above, to approximate the given density distribution 304.

The computing device 100, using the density adjustment module 404, may generate, e.g. using the density adjustment function 306, a modified point cloud 406 based on the raw point cloud 402 and updated density parameters 414, as described hereinbelow.

The object detection module 408 may receive the modified point cloud 406, the object detection module 408 to be used by the computing device 100 for detecting objects in the modified point cloud 406. In some embodiments, the object detection module 408 may include a centerpoint object detector, as described in Y in, T. et al., Center-based 3D Object Detection and Tracking, Proceedings of the IEEE/CVF Conference on Computer Vision and Pattern Recognition (CVPR), 2021, the contents of which are hereby incorporated by reference in its entirety, where the computing device 100 is configured to use the object detection module 408 to determine the center of a bounding box corresponding to an object. In some embodiments, the object detection module 408 may include a Point-Voxel Region Based Convolutional Neural Network (PV-RCNN) object detector, where the computing device 100 is configured to use the object detection module 408 to generate 3D object proposals based on learned discriminative features of keypoints, as described in Shaoshuai, S. et al., PV-RCNN: Point-Voxel Feature Set Abstraction for 3D Object Detection, Computer Vision Foundation, 2020, the contents of which are hereby incorporated by reference. In some embodiments, the object detection module 408 may include a Point Density-A ware Voxel Network (PDV) object detector, as described in Hu, J. et al., Point Density-A ware Voxels for LiDAR 3D Object Detection, Proceedings of the IEEE/CVF Conference on Computer Vision and Pattern Recognition (CVPR), 2022, the contents of which are hereby incorporated by reference in its entirety, where the computing device 100 is configured to use the object detection module 408 to generate spatially localized voxel features to improve bounding box confidences of 3D objects.

The computing device 100 may use the object detection module 408 to generate a performance score 410, the performance score 410 being indicative of a detection performance of the object detection module 408 on the modified point cloud 406. In some embodiments, the performance score 410 may include a loss value output by a loss function of the object detection module 408, the loss value being indicative of a difference between detected objects in a training point cloud and ground-truth objects in the training point cloud. Alternatively, in some embodiments, the performance score 410 may include a vector of posterior probabilities 810, as described in further detail hereinbelow with reference to FIG. 8A.

In some embodiments, the loss function may be computed as follows:

$$L = {\sum }_{r} {β}_{r} {L}_{p , r} + {β}_{s} {L}_{smoothness} \qquad ( 1 )$$

where:
ΣᵣβᵣL_{p,r} is a term corresponding to the object detection module 408;
βₛLₛₘₒₒₜₕₙₑₛₛ is a density smoothness term;
L_{p,r} is the loss from the object detection module 408 at range r;
Lₛₘₒₒₜₕₙₑₛₛ is a density smoothness term to prevent large density discontinuities from range to range; and
βᵣ and βₛ are scalars to control the contributions from each loss term.

In some embodiments, Lₛₘₒₒₜₕₙₑₛₛ may be defined as the variance of the set of mean object densities from each distance range. The object densities may be computed by counting the number of 3D points that fall within an object's 3D bounding box, and normalized by the 3D box volume.

A density optimization module 412 may receive the performance score 410, the density optimization module 412 being executable by the computing device 100. The computing device 100, using the density optimization module 412, may automatically output, using the performance score 410 and previous density parameters 416, the updated density parameters 414 for the density adjustment module 404.

Developers of the present technology have realized that current solutions rely on manual adjustments of density parameters, which have a number of drawbacks with existing approaches, namely modifying a point cloud from a dataset using manually-chosen parameters, training/evaluating a perception mode with the modified data can take up to several days. Further, parameters need to be re-selected if the experimental setup is changed, such as through a change of datasets or a change of perception model. Lastly, processing and saving the modified data can take additional processing time and storage. Developers of the present technology have realized that automatically providing the updated density parameters 414, as opposed to manually providing them via a trial and error approach, for example, is beneficial in terms of time necessary for training and using 408 on the raw point cloud 402.

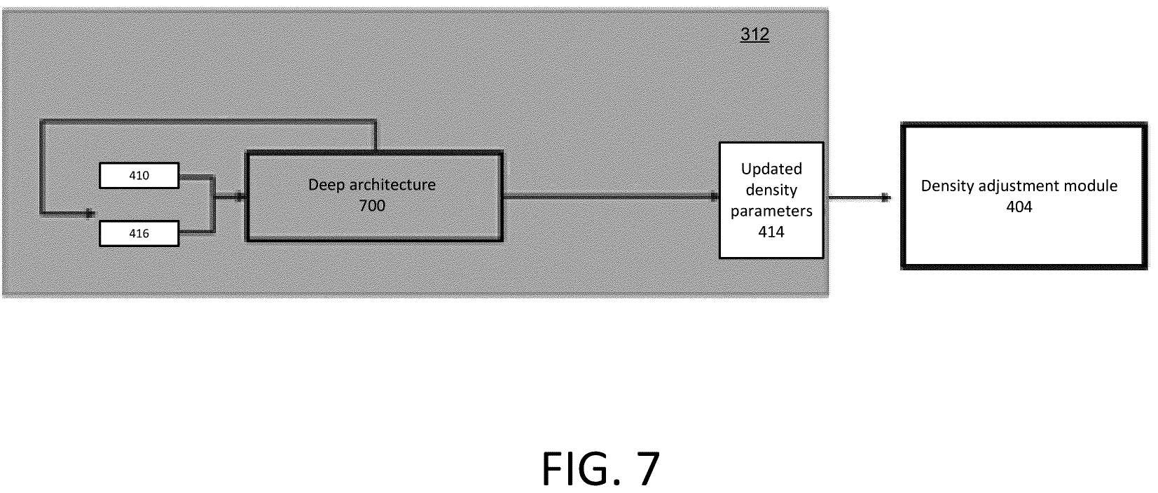

In some embodiments, the density optimization module 412 may be implemented as a machine learning module. In some embodiments, the machine learning module may include a plurality of multi-layer perceptrons (M LPs) arranged in parallel, as described hereinbelow with reference to FIG. 7, which illustrates a single iteration of training of the deep architecture 700 in accordance with a non-limiting embodiment of the present technology. Other machine learning embodiments of the density optimization module 412 are also possible.

In some embodiments, the density optimization module 412 may be implemented as a non-machine learning embodiment, such as a probabilistic embodiment, as described hereinbelow with reference to FIG. 8A.

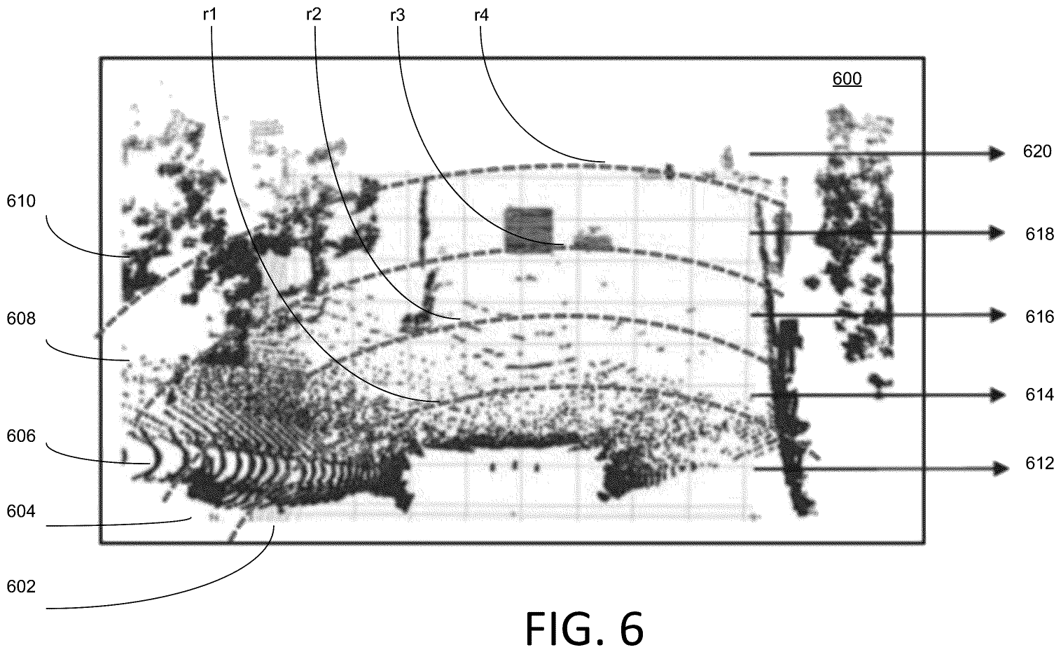

In some embodiments, the raw point cloud 402 may include a first set of points in a first pre-determined distance interval, for instance the first pre-determined distance interval 308, and a second set of points in a second pre-determined distance interval, for instance the second pre-determined distance interval 310. One or more than two pre-determined distance intervals may also be used, as will be described hereinbelow with reference to FIG. 6. The first set of points may be associated with a first density distribution, for instance the first density distribution component 312, and the second set of points may be associated with a second density distribution, for instance the second density distribution component 314, the first density distribution different from the second density distribution.

In some embodiments, the computing device 100, using the density adjustment module 404, may generate a modified first set of points based on the first set of points and a first density parameter for the density adjustment function 306, and a modified second set of points based on the second set of points and a second density parameter for the density adjustment function 306. The modified first set of points may have a modified first density distribution that is different from the first density distribution, and the modified second set of points may have a modified second density distribution that is different from the second density distribution. In some embodiments, the first density parameter may have been automatically determined for the first pre-determined distance interval 308 during training of the object detection module 408, as described hereinbelow, and the second density parameter may have been automatically determined for the second pre-determined distance interval 310 during training of the object detection module 408. Finally, the computing device 100, using the density adjustment module 404, may generate a modified point cloud 406 based on a combination of the first modified set of points and the second modified set of points.

Not all of the depicted components may be required, however, and one or more implementations of the object detection system 400 may include additional components not shown in FIG. 4. Variations in the arrangement and type of the components may be made without departing from the spirit or scope of the claims asset forth herein. Additional components, different components, or fewer components may be provided.

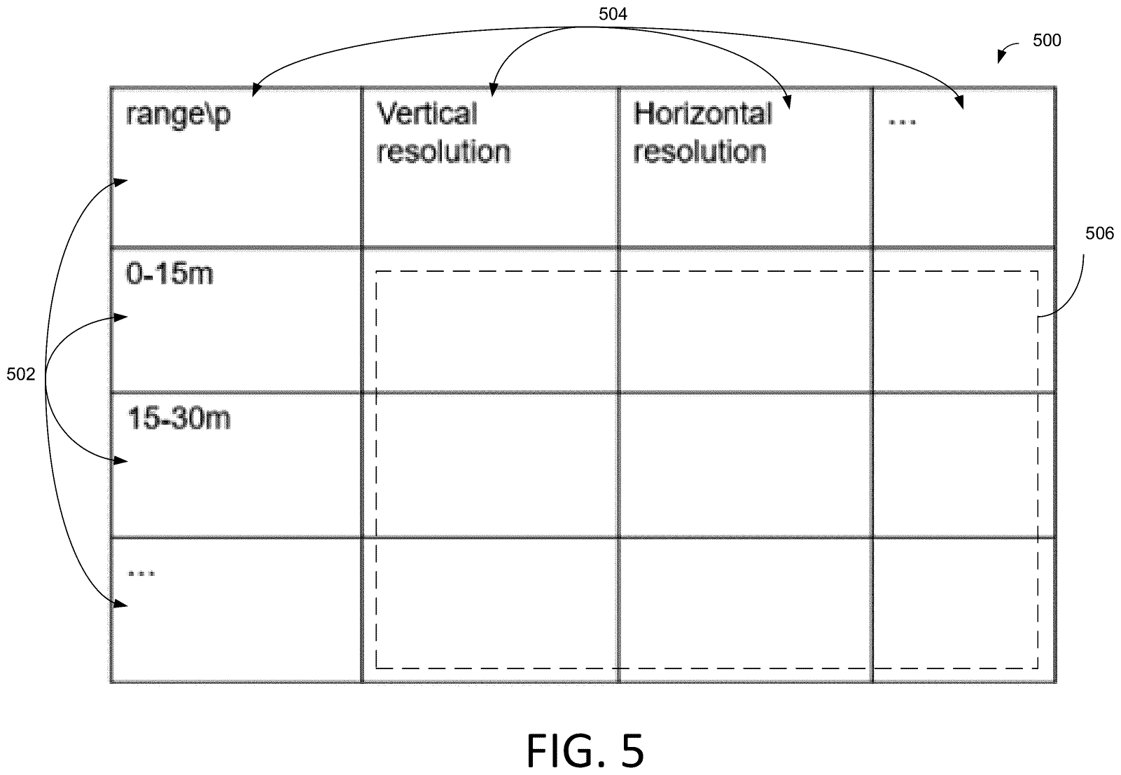

Referring to FIG. 5, a 2D array 500 of one or more density parameters in a plurality of ranges retrieved from a storage, the storage being accessible by the computing device 100, will now be described. The computing device 100 may arrange density parameters for the object detection system 400, including but not limited to the updated density parameters 414, the previous density parameters 416, the first density parameter and the second density parameter, in the 2D array 500, which may be stored in the memory 104 of the computing device 500. Further, the computing device 100 may be configured to iteratively update data in the 2D array 500 while executing the object detection system 400. M ore specifically, the computing device 100 can generate the 2D array 500 with initial data and update the 2D array with density parameters corresponding to a current iteration.

Rows 502 of the 2D array 500 may correspond to pre-determined distance intervals, for instance the first pre-determined distance interval 308 and the second pre-determined distance interval 310. Columns 504 of the 2D array 500 may correspond to individual density parameters input to the density adjustment module 404, for instance the updated density parameters 414. Cells 506 of the 2D array 500 may correspond to values of the density parameters for the object detection system 400 in the pre-determined distance intervals. In a non-limiting example, a given parameter, such as vertical resolution, may have a first value in a pre-determined distance range of 0-15 m, a second value in a pre-determined distance range of 15-30 m, and so on.

In some embodiments, the density parameters for the object detection system 400, including at least the updated density parameters 414, the previous density parameters 416, the first density parameter and the second density parameter, may include at least one of a vertical sensor resolution, a horizontal sensor resolution, a distance range, a neighbor point association distance threshold, a subsampling factor, an interpolation factor, a vertical minimum angle between points, and a horizontal minimum angle between points, among other possibilities.

The density parameters for the object detection system 400 may also be stored in alternative data structures not limited to the 2D array 500, as will be recognized by the person skilled in the art.

Referring to FIG. 6, a diagram illustrating a spatially partitioned point cloud 600 captured by a LiDAR system at a geographical location will now be described, in accordance with a non-limiting embodiment of the present technology. The spatially partitioned point cloud 600 may include, for example, the first point cloud 200 captured by the first LiDAR system, and may include a corresponding number of 3D points in a dataset. In some embodiments, each 3D point may be defined using a Cartesian coordinate system (x,y,z). Alternatively, in some embodiments, each 3D point may be defined using a spherical coordinate system (r, θ, ϕ). Other possibilities may apply, as will be recognized by the person skilled in the art.

In some embodiments of the present technology, the spatially partitioned point cloud 600 may be spatially partitioned (also be referred to as “divided” or “segmented”) into a plurality of pre-determined distance intervals, for instance the pre-determined distance intervals 602, 604, 606, 608, and 610. In some embodiments, this spatial partitioning may be performed automatically, for instance by the computing device 100 using the density adjustment module 404. The pre-determined distance interval 602 may include all points located within a distance r1 (also referred to herein as a “range”) from the LiDAR system. The pre-determined range 604 may include all points located within a distance r1 to r2 from the LiDAR system. The pre-determined range 606 may include all points located within a distance r2 to r3 from the LiDAR system. The pre-determined range 608 may include all points located within a distance r3 to r4 from the LiDAR system. Finally, the pre-determined range 610 may include all points located within a distance greater than r4 from the LiDAR system. In some embodiments, the distances r1, r2, r3, and r4 may each be defined as a Euclidean distance d along a ground plane (x,y) at the geographical location, where d=\sqrt{x²+y²}. Other possibilities may apply, as will be recognized by the person skilled in the art having the benefit of the present disclosure.

Each of the pre-determined distance intervals 602, 604, 606, 608, and 610 may have associated thereto a set of density parameters 612, 614, 616, 618, and 620, respectively. The computing device 100, using the density adjustment function 306, may associate to each set of density parameters 612, 614, 616, 618, and 620 a density distribution, which may be adjusted separately. Additionally, the computing device 100, using the density optimization module 412, may separately update each set of density parameters 612614616618620. In some embodiments, the computing device 100 may generate the updated density parameters 414 based on a combination of the sets of density parameters 612, 614, 616, 618, and 620.

In some embodiments, the computing device 100, e.g. using the object detection module 408, may compute a partial performance score for each of the pre-determined distance intervals 602, 604, 606, 608, and 610, each partial performance score being indicative of a detection performance of the object detection module 408 on the spatially partitioned point cloud 600 in each of the pre-determined distance intervals 602, 604, 606, 608, and 610. The computing device 100, using the object detection module 408, may generate the performance score 410 based on a combination of each partial performance score.

Referring to FIG. 7, a block diagram of the density optimization module 412 according to a non-limiting machine learning embodiment of the present technology will be described. The density optimization module 412 may include a deep architecture 700. In some embodiments, the deep architecture 700 may include a plurality of multi-layer perceptrons (M LPs) arranged in parallel, where the computing device 100 is configured to use each one of the plurality of multi-layer perceptrons (MLPs) to process each of the pre-determined distance intervals 602, 604, 606, 608, 610 of the spatially partitioned point cloud 600.

The inputs of the deep architecture 700 may include the previous density parameters 416 concatenated with the performance score 410. The output of the deep architecture 700 may include the updated density parameters 414. The density adjustment module 404 may receive the updated density parameters 414.

Referring to FIG. 7A, an MCMC system 800 for detecting objects in surroundings of a LiDAR system will be described, according to a non-limiting embodiment of the present technology. As described in further detail hereinbelow, the computing device 100, using the MCMC system 800, may estimate target density hyper-parameters 814 of an unknown underlying given density distribution of an in-use point cloud 802 such that a first component p₀ of the vector of posterior probabilities 810, representative of a probability of detecting objects in the in-use point cloud 802 via an object detection module 808 is maximized. The MCMC system 800 may be implemented as a non-limiting embodiment of the object detection system 400. The object detection module 808 may be implemented as a non-limiting embodiment of the object detection module 408.

The MCMC system 800 may include the in-use point cloud 802, designated P, captured by a LiDAR system, for instance the first point cloud 200 captured by the first LiDAR system.

A resampling module 804 may receive the in-use point cloud 802, the resampling module 804 being executable by the computing device 100. The resampling module 804 may be implemented as a non-limiting embodiment of the object detection module 408. The computing device 100, using the resampling module 804, may implement the density adjustment function 306, where the density adjustment function 306, here designated R(P,\vec{θ′}), may include resampling the in-use point cloud 802 using the target density hyper-parameters 814. The computing device 100, using the resampling module 804, may generate, e.g. using the target density hyper-parameters 814, a modified in-use point cloud 806, designated P*, based on the in-use point cloud 802, as described in further detail hereinbelow.

806 The object detection module 808 may receive the modified in-use point cloud 806, the computing device 100 using the object detection module 808 for detecting objects in the modified in-use point cloud 806. The object detection module 808 may be designated by f(P*,π), where P* is the modified in-use point cloud 806 and π are trainable model parameters of the object detection module 808.

The computing device 100, using the object detection module 808, may generate the vector of posterior probabilities 810, the vector of posterior probabilities 810 being indicative of a detection performance of the object detection module 808 on the modified in-use point cloud 806. The vector of posterior probabilities 810, designated \vec{p}, may include at least the first component representative of an overall posterior probability p₀ of the modified in-use point cloud 806 and a subsequent component representative of a posterior probability in a pre-determined distance interval of the modified in-use point cloud 806. In a non-limiting example, the vector of posterior probabilities 810 may include the first component p₀ of the modified in-use point cloud 806 and subsequent components p₁, p₂, p₃, p₄, and p₅ representative of posterior probabilities in the pre-determined distance intervals 602, 604, 606, 608, and 610 of the modified in-use point cloud 806, respectively. It is desirable to maximize at least the first component p₀ of the vector of posterior probabilities 810, indicating a highest average chance of object detection by the object detection module 808 in all the pre-determined distance intervals 602, 604, 606, 608, and 610 of the modified in-use point cloud 806.

810 An MCMC-based density optimization module 812 may receive the vector of posterior probabilities 810, the MCMC-based density optimization module 812 being executable by the computing device 100. The computing device 100, using the MCMC-based density optimization module 812, may iteratively output, using the vector of posterior probabilities 810, proposals for the target density hyper-parameters 814 that improve the detection performance of the object detection module 808, as described below.

In the MCMC-based density optimization module 812, a proposal distribution is selected to sample the target density hyper-parameters 814. After initializing \vec{θ} with a value \vec{θ₀} (e.g. \vec{θ₀}=[0, 0, 0, 0, 0] in an embodiment with 5 pre-determined distance intervals) and \vec{p} (e.g. \vec{p}=[1, 1, 1, 1, 1, 1], where p₀=1), a hyper-parameter space corresponding to the target density hyper-parameters 814 may be quantized and samples drawn using discrete step perturbations, e.g. of size δ₀=0.05. The sign of the discrete step perturbations may be generated from a bi-nomial distribution with p=0.5. For a Markov chain component of the MCMC-based density optimization module 812, only one component of \vec{θ} is perturbed using δ_{θ}. In this embodiment, the computer device 100 may employ a non-machine learning model, such as a probabilistic model using Markov chains to generate predicted outputs. In a typical use-case, the density of the in-use point cloud 802 at closer ranges is higher than at ranges farther away (see FIG. 2), potentially by several orders of magnitude. Therefore, the first components of \vec{θ} (representing closer ranges) are perturbed more and more often than the last components of \vec{θ}. A n element selection index may be drawn from a zero-mean 1D Gaussian distribution j˜N(0,σ²), with σ=0.5, where index=|round(j)|, and index∈[1,5]. index may then be used to select the component of \vec{θ} that will be perturbed to generate the proposal distribution. The proposal distribution may be computed as \vec{θ′}(new)=\vec{θ′}(previous), and then \vec{θ′}[index]=\vec{θ′}[index]+δ_{θ}.

The computing device 100 may use a dataset X without any resampling to perform a standard supervised training of the object detection module 808, without MCMC, saving a best model checkpoint \hat{π}, indicative of the best candidates among the trainable model parameters π of the object detection module 808, and discarding any intermediate checkpoints. Subsets X₁₀₀₀ and X₂₅₀ of X may be selected by deterministic sampling, corresponding to 1000 training point clouds and 250 validation point clouds, respectively. The computing device 100 may use X₁₀₀₀ and X₂₅₀, by the MCMC-based density optimization module 812. to generate a best candidate \vec{θ′}. It should be apparent that subsets other than X₁₀₀₀ and X₂₅₀ may be used without deviating from the scope of the present technology.

Once the MCMC iterative procedure is complete, the best candidate \vec{θ′} may be used to start a standard supervised training and evaluation (from scratch) of the object detection module f(P*,π), with R(\vec{θ′}) set to use the best candidate \vec{θ′}.

Algorithm 1, presented below, summarizes the operation of the MCMC system 800 according to a non-limiting embodiment of the present technology:

Algorithm 1 MCMC iterations

| | |
|---|---|
| 1: | Initialize \vec{θ} = \vec{θₒ} = [1, 1, 1, 1, 1], |
| 2: | \vec{p} = \vec{pₒ} = [0, 0, 0, 0, 0, 0] |
| 3: | N = number of iterations |
| 4: | for i = 1 → N do |
| 5: | Initialize the detector f(\hat{π}) |
| 6: | Using X₁₀₀₀ and X₂₅₀, run one epoch of detector |
| | finetuning with P* = R(P, \vec{θ′}) where, \vec{θ′} is a proposal |
| | from the MCMC at iteration i. |
| 7: | Accept or reject \vec{θ′} and proceed to the next iteration |
| 8: | end for |

Referring to FIG. 8B, an arrow process diagram showing the evolution of the target density hyper-parameters 814 will be described. Starting with the initialized target density hyper-parameters 822, designated \vec{θ₀}, the target density hyper-parameters 814 are updated during iterations of the MCMC system 800 to intermediate target density hyper-parameters 824 and 826, until the final target density hyper-parameters 828, designated \vec{θ′}, are reached.

Referring to FIG. 9, a method 900 for generating a modified point cloud will be described, the method 900 being executable by the computing device 100.

The method 900 begins at step 902, and the computing device 100 is configured, at step 904, to acquire a raw point cloud captured by a LiDAR system, e.g. the first point cloud 200 captured by the first LiDAR system, where the raw point cloud includes a first set of points in a first pre-determined distance interval, e.g. the first pre-determined distance interval 308, and a second set of points in a second pre-determined distance interval, e.g. the second pre-determined distance interval 310, and where the first set of points is associated with a first density distribution, e.g. the first density distribution component 312, and the second set of points is associated with a second density distribution, e.g. the second density distribution component 314, the first density distribution being different from the second density distribution.

At step 906, the computing device 100 is configured to generate, using a density adjustment function, e.g. the density adjustment function 306, a modified first set of points based on the first set of points and a first density parameter for the density adjustment function 306, where the modified first set of points has a modified first density distribution that is different from the first density distribution, and the first density parameter having been automatically determined for the first pre-determined distance interval during training of an object detection module, e.g. the object detection module 408, the computing device 100 using the object detection module 408 for detecting objects in the modified point cloud.

At step 908, the computing device 100 is configured to generate, using a density adjustment function, e.g. the density adjustment function 306, a modified second set of points based on the second set of points and a second density parameter for the density adjustment function 306, the modified second set of points having a modified second density distribution that is different from the second density distribution, and the second density parameter having been automatically determined for the second pre-determined distance interval during training of the object detection model.

Finally, at step 910, the computing device 100 is configured to generate the modified point cloud based on a combination of the first modified set of points and the second modified set of points, after which the method 900 may end (step 912).

Referring to FIG. 10, a method 1000 for detecting objects in surroundings of a LiDAR system will be described.

The method 1000 begins at step 1020, with the computing device 100 configured, at step 1040, to execute, using a density optimization model, e.g. the MCMC-based density optimization module 812, an iterative process 1240 for automatically generating a target density parameter (step 1120), e.g. the target density hyper-parameters 814 for an in-use point cloud, e.g. the in-use point cloud 802. The iterative process 1240 includes a given iteration 1200 including steps 1060 and 91080 and a subsequent iteration 1220 including steps 1100 and 1120.

At step 1060, during the given iteration 1200 of the iterative process 1240, the computing device 100 is configured to acquire a performance score, e.g. the vector of posterior probabilities 810, from an object detection module, e.g. the object detection module 808, the performance score being indicative of a detection performance of the object detection module.

At step 91080, the computing device 100 is configured to generate, using the density optimization model, a new candidate density parameter based on the performance score and a previous candidate density parameter from a previous iteration, after which the method 1000 may proceed to the subsequent iteration 1220.

At step 1100, during the subsequent iteration 1220, the computing device 100 is configured to acquire a new performance score from the object detection model, the performance score being indicative of a detection performance of the object detection model on a modified training point cloud generated using the training point cloud and the new candidate density parameter.

At step 1120, the computing device 100 is configured to generate the target density parameter based on the new performance score and the new candidate density parameter from the given iteration, after which the iterative process 1240 may end, and the method 1000 may proceed to step 1140.

In some embodiments of the present technology, at step 1120, the computing device 100 may be configured to update the new candidate density parameter and thereby a second new candidate density parameter and/or the target density parameter. The computing device 100 may be configured to perform such an update based on a new performance score and the new candidate density parameter from the given iteration. The new performance score is indicative of a detection performance of the object detection model on a modified training point cloud generated using the training point cloud and the new candidate density parameter.

At step 1140, the computing device 100 is configured to generate, using a density adjustment function, e.g. the density adjustment function 306 implemented by the resampling module 804, a modified in-use point cloud, e.g. the modified in-use point cloud 806 using the target density parameter, the in-use point cloud having been captured by the LiDAR system in the surroundings, and the modified in-use point cloud having a different density distribution than the in-use point cloud.

Finally, at step 1160, the computing device 100 is configured to generate, using the object detection model, a predicted output indicative of detected objects in the surroundings using the modified in-use point cloud, instead of the in-use point cloud, after which the method 1000 may end (step 1180).

1. A method of generating a modified point cloud based on a raw point cloud, the raw point cloud being captured by a LiDAR system, the method executable by a computing device communicatively coupled to the LiDAR system, the method comprising:
acquiring, by the computing device, the raw point cloud,
the raw point cloud including a first set of points in a first pre-determined range interval and a second set of points in a second pre-determined distance interval,
the first set of points associated with a first density distribution and the second set of points associated with a second density distribution, the first density distribution being different from the second density distribution;
generating, by the computing device using a density adjustment function, a modified first set of points based on the first set of points and a first density parameter for the density adjustment function,
the modified first set of points having a modified first density distribution that is different from the first density distribution,
the first density parameter having been automatically determined for the first pre-determined distance interval during training of an object detection model, the object detection model to be used for detecting objects in the modified point cloud;
generating, by the computing device using the density adjustment function, a modified second set of points based on the second set of points and a second density parameter for the density adjustment function,
the modified second set of points having a modified second density distribution that is different from the second density distribution,
the second density parameter having been automatically determined for the second pre-determined distance interval during training of the object detection model; and
generating, by the computing device, the modified point cloud based on a combination of the first modified set of points and the second modified set of points.

2. The method of claim 1, wherein the point cloud is a 3D point cloud.

3. The method of claim 1, wherein the object detection model is a centerpoint object detector configured to determine the center of a bounding box corresponding to an object.

4. The method of claim 1, wherein the object detection model is a Point-Voxel Region Based Convolutional Neural Network (PV-RCNN) object detector configured to generate 3D object proposals based on learned discriminative features of keypoints.

5. The method of claim 1, wherein the object detection model is a Point Density-Aware Voxel Network (PDV) object detector configured to generate spatially localized voxel features to improve bounding box confidences of 3D objects.

6. The method of claim 1, wherein the first set of points in the first pre-determined distance interval is within a first pre-determined range from the LiDAR system and the second set of points in the second pre-determined distance interval is within a second pre-determined range from the LiDAR system but above the first pre-determined range, the second pre-determined range greater than the first pre-determined range.

7. The method of claim 1, wherein the first density parameter and the second density parameter comprise at least one of a vertical sensor resolution, a horizontal sensor resolution, a distance range, a neighbor point association distance threshold, a subsampling factor, an interpolation factor, a vertical minimum angle between points, and a horizontal minimum angle between points.

8. A method of detecting objects in surroundings of a LiDAR system, the method executable by a computing device, the computing device being communicatively coupled to the LIDAR system, the method comprising:
executing, by the computing device employing a Markov Chain Monte Carlo (MCMC) model, an iterative process for automatically generating a target density parameter for an in-use point cloud, the executing including:
during a given iteration of the iterative process:
acquiring, by the computing device, a performance score from an object detection model, the performance score being indicative of a detection performance of the object detection model;
generating, by the computing device employing the MCMC model, a new candidate density parameter based on the performance score and a previous candidate density parameter from a previous iteration,
during a subsequent iteration of the iterative process:
updating, by the computing device employing the MCMC model, the new candidate density parameter, thereby determining the target density parameter, the updating being based on a new performance score and the new candidate density parameter from the given iteration,
the new performance score being indicative of a detection performance of the object detection model on a modified training point cloud generated using the training point cloud and the new candidate density parameter;
generating, by the computing device employing a density adjustment function, a modified in-use point cloud using the in-use point cloud and the target density parameter,
the in-use point cloud having been captured by the LiDAR system in the surroundings,
the modified in-use point cloud having a different density distribution than the in-use point cloud; and
generating, by the computing device employing the object detection model, a predicted output indicative of detected objects in the surroundings using the modified in-use point cloud, instead of the in-use point cloud.

9. The method of claim 8, wherein the object detection model is a centerpoint object detector configured to determine the center of a bounding box corresponding to an object.

10. The method of claim 8, wherein the object detection model is a Point-Voxel Region Based Convolutional Neural Network (PV-RCNN) object detector configured to generate 3D object proposals based on learned discriminative features of keypoints.

11. The method of claim 8, wherein the object detection model is a Point Density-Aware Voxel Network (PDV) object detector configured to generate spatially localized voxel features to improve bounding box confidences of 3D objects.

12. The method of claim 8, wherein the target density parameter, the new candidate density parameter, and the previous candidate density parameter comprise at least one of a vertical sensor resolution, a horizontal sensor resolution, a distance range, a neighbor point association distance threshold, a subsampling factor, an interpolation factor, a vertical minimum angle between points, and a horizontal minimum angle between points.

13. The method of claim 8, wherein the performance score comprises a vector of posterior probabilities indicative of the performance of the object detection model, the vector comprising at least a first component representative of an overall posterior probability of the in-use point cloud and a subsequent component representative of a posterior probability in a pre-determined distance interval of the in-use point cloud.

14. The method of claim 8, wherein the target density parameter maximizes the first component representative of the overall posterior probability of the in-use point cloud.

15. The method of claim 8, wherein
the in-use point cloud and the modified in-use point cloud comprise a first set of points in a first pre-determined distance interval and a second set of points in a second pre-determined distance interval, the first set of points associated with a first density distribution and the second set of points associated with a second density distribution, the first density distribution being different from the second density distribution, and
the target density parameter, the new candidate density parameter, and the previous candidate density parameter comprise a vector of density parameters, the vector comprising at least a first component representative of a first density parameter in the first pre-determined range and a second component representative of a second density parameter in the second pre-determined range.

16. A computing device for detecting objects in surroundings of a LiDAR system, the computing device being communicatively coupled to the LIDAR system, the computing device being configured to:
execute, employing a Markov Chain Monte Carlo (MCMC) model, an iterative process for automatically generating a target density parameter for an in-use point cloud, the executing including:
during a given iteration of the iterative process:
acquire a performance score from an object detection model, the performance score being indicative of a detection performance of the object detection model;
generate, employing the MCMC model, a new candidate density parameter based on the performance score and a previous candidate density parameter from a previous iteration,
during a subsequent iteration of the iterative process:
update, employing the MCMC model, the new candidate density parameter, thereby determining the target density parameter, the updating being based on a new performance score and the new candidate density parameter from the given iteration,
the new performance score being indicative of a detection performance of the object detection model on a modified training point cloud generated using the training point cloud and the new candidate density parameter;
generate, employing a density adjustment function, a modified in-use point cloud using the in-use point cloud and the target density parameter,
the in-use point cloud having been captured by the LiDAR system in the surroundings,
the modified in-use point cloud having a different density distribution than the in-use point cloud; and
generate, employing the object detection model, a predicted output indicative of detected objects in the surroundings using the modified in-use point cloud, instead of the in-use point cloud.

17. The computing device of claim 16, wherein the target density parameter includes a first density parameter for the density adjustment function and a second density parameter for the density adjustment function.

18. The computing device of claim 16, wherein, said generate, employing the density adjustment function, the modified in-use point cloud using the in-use point cloud and the target density parameter includes:
acquiring the in-use point cloud;
the in-use point cloud includes a first set of points in a first pre-determined range interval and a second set of points in a second pre-determined distance interval,
the first set of points associated with a first density distribution and the second set of points associated with a second density distribution, the first density distribution being different from the second density distribution,
generating, using the density adjustment function, a modified first set of points based on the first set of points and a first density parameter for the density adjustment function,
the modified first set of points having a modified first density distribution that is different from the first density distribution,
the first density parameter having been automatically determined for the first pre-determined distance interval during training of the object detection model;
generating, using the density adjustment function, a modified second set of points based on the second set of points and a second density parameter for the density adjustment function,
the modified second set of points having a modified second density distribution that is different from the second density distribution,
the second density parameter having been automatically determined for the second pre-determined distance interval during training of the object detection model; and
generating the modified in-use point cloud based on a combination of the modified first set of points and the modified second set of points.
